(19) United States
(12) Patent Application Publication
(10) Pub. No.: US 2016/0360121 A1
(43) Pub. Date: Dec. 8, 2016

(54) PORTABLE DEVICE WITH SUCCESSIVE EXTENSION ZOOMING CAPABILITY

(71) Applicants: Yi-Chuan CHENG, Changhua County (TW); Kuo-Ching Chiang, New Taipei City (TW)

(72) Inventors: Yi-Chuan CHENG, Changhua County (TW); Kuo-Ching Chiang, New Taipei City (TW)

(21) Appl. No.: 15/242,520

(22) Filed: Aug. 20, 2016

Related U.S. Application Data
(63) Continuation-in-part of application No. 12/942,649, filed on Nov. 9, 2010.

(30) Foreign Application Priority Data
Nov. 9, 2009 (TW) 098137971

(51) Int. Cl. H04N 5/232; H04N 13/02

(52) U.S. Cl. CPC H04N 5/23296; H04N 13/0242; H04N 5/23293

(57) ABSTRACT

A portable communication device with zoom capability comprises a control unit; a first communication module coupled to the control unit; a display coupled to the control unit; and an image capture module having a first camera unit with a first tunable lens and a first image sensor, and a second camera unit with a second lens and a second image sensor; wherein the first tunable lens has zoom capability with a first zoom range; and the second lens has a fixed focal length or the second lens is a second tunable lens has a second zoom range different from the first zoom range.

### CROSS REFERENCE TO RELATED APPLICATIONS

This application is a Continuation-In-Part application of U.S. patent application Ser. No. 12/942,649, filed on Nov. 9, 2010, now pending, which is a counterpart foreign application of TAIWAN Patent Application No. 098137971, filed on Nov. 9, 2009. The contents of the above-mentioned patent applications is hereby incorporated by reference herein in its entirety and made a part of this specification.

### TECHNICAL FIELD

The present invention generally relates to a portable device, especially to a portable communication device with at least dual images capture devices.

### DESCRIPTION OF RELATED ARTS

In pace with the development of IT (information technology), information can be exchanged with higher speed and greater capacity. The third generation mobile protocol can make users enjoy diverse services, and immediately information exchange is executable such that live broadcast can be watched via the mobile communication internet or the Internet. However, there is no portable communication device capable of generating stereo images.

### SUMMARY

The present invention provides a method for a portable communication device to play stereo image, the steps are described as follows: at first, the portable communication device with a stereo image capture module is provided, wherein the portable communication device includes a control unit, a first communication module coupled to the control unit, a display coupled to the control unit; the stereo image capture module being coupled to the control unit to facilitate to capture stereo image, and a stereo image generation module coupled to the control unit for generating stereo image from data received from the stereo image capture module, wherein the stereo image generation module can be stored in a remote computer, a remote server, or the portable communication device, wherein the stereo image capture module comprises two image capture elements arranged linearly with a distance; and then, two images are captures by the stereo image capture module; and next, a stereo image is generated from the captured two images by the stereo image generation module, and finally, the stereo image is stored.

In another aspect, a portable communication device with a stereo image capture module is disclosed, which includes: a control unit, a display coupled to the control unit, a stereo image capture module coupled to the control unit to facilitate to capture stereo image, and a stereo image generation module coupled to the control unit for generating stereo image from data received from the stereo image capture module. The stereo image capture module comprises two image capture elements arranged linearly with a distance approximate to the distance between two pupils of human, and those image capture elements comprise CMOS or CCD and can be arranged parallel to the major axis of the portable communication device.

A short range wireless interne module can be further included, which comprises Wi-Fi module, or 802.11 module, wherein a WiMAX (Worldwide Interoperability for Microwave Access) module can also be introduced.

In one another aspect, a portable communication device with zoom capability comprises a control unit; a first communication module coupled to the control unit; a display coupled to the control unit; an image capture module having a first camera unit with a first tunable focal length lens to capture a first image of a first visual field, and a second camera unit with a second lens to capture a second image of a second visual field; and an image segmentation module coupled to the control unit to divide display areas of the display; wherein the first tunable focal length lens has zoom capability and the second lens has a fixed focal length.

In yet another aspect, an image capture module having a first camera unit with a first tunable focal length lens, and a second camera unit with a second tunable focal length lens; wherein the first tunable focal length lens has a first zoom capability and the second camera unit has a second zoom capability, and wherein the first tunable focal length lens has a first zoom range and the second tunable focal length lens has a second zoom range different from said first zoom range.

The portable communication device further comprises at least one image sensor for the first camera unit and the second camera unit. The portable communication device further comprises a third camera unit with a second tunable focal length lens to capture a third image of a third visual field.

The portable communication device further comprises a zoom selector coupled to the control unit.

The portable communication device further comprises a second communication module coupled to the control unit. The second communication module includes Wi-Fi module or light signal communicating module.

The first camera module and the second camera module are formed rear or front side of the portable communication device. The first tunable focal length lens is an electrically tunable-focusing element, an electrically tunable-focusing liquid lens or an electrically tunable-focusing liquid crystal lens.

### BRIEF DESCRIPTION OF THE DRAWINGS

FIG. 1 shows the diagram of the present invention.

FIG. 2 and 3 show the example arrangement of the camera of the present invention.

FIG. 4 shows the embodiment of the present invention.

FIG. 5 shows the embodiment of the present invention.

FIG. 6 shows the embodiment of the present invention.

### DESCRIPTION DESCRIPTION

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims. The present invention can be integrated in the device such as a mobile phone, a digital video camera, a digital camera, a PDA, a smart phone, a GPS, a tablet, or notebook, etc. The following embodiment is just to illustrate rather than limiting the present invention.

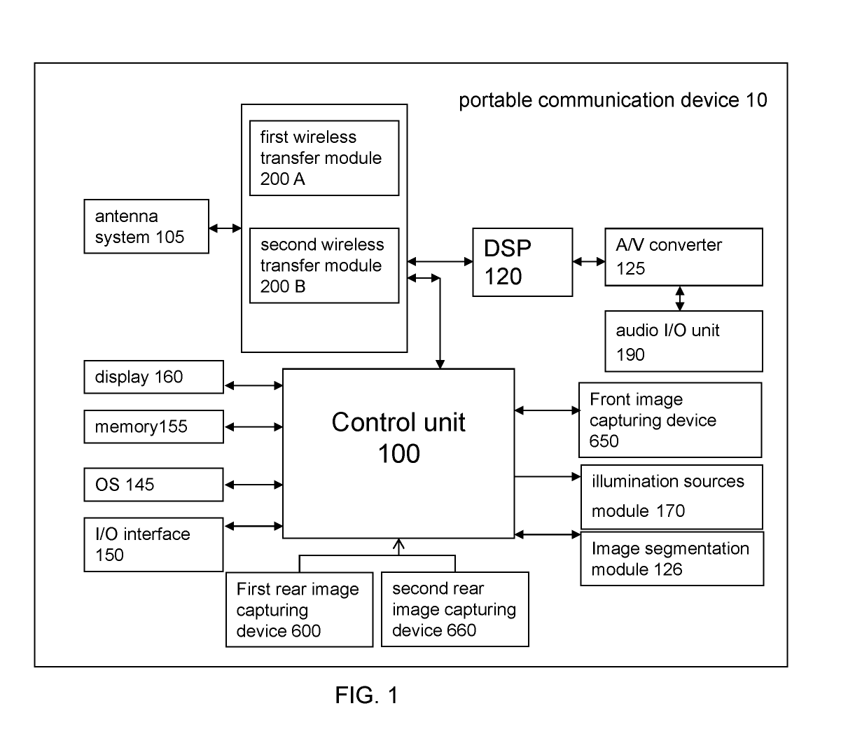

FIG. 1 exhibits a functional diagram of the portable communication device 10 with at least dual images capture modules or devices. If the portable communication device is a cell phone, it may comprise the SIM card connector for carrying the SIM card, which is well known in the art, and hence it will not be described redundantly hereinafter. In other types of cell phones, such as PHS or some CDMA systems, the SIM card is not certainly necessary. The figure is introduced to explain rather than limiting the present invention. The portable communication device 10 includes a wireless data transfer module 200A, which can be a video RF module for transmitting or receiving mobile signals, and aforementioned module is well known by skilled persons in the art. As well known, the RF module is coupled to an antenna system 105, which may be single or multiple antennas according to demands, and it may further include the base band processor. The antenna system is connected to a radio transceiver for transmitting or receiving signals. The wireless data transfer module 200A is compatible with various mobile communication protocols, such as W-CDMA, CDMA2000, CDMA2001, TD-CDMA, TD-SCDMA, UWC0136, DECT, 4G systems or higher specification. These systems allow users to communicate through video telephone. The RF module may be introduced to perform transmitting and receiving of signals, frequency synchronization, base band processing, and digital signals processing, etc. The hardware interface of SIM card is used to contain (or insert) a SIM card. And finally, signals can be transmitted to the final actuators, that is, the audio I/O (input/output) unit 190. However, if the portable communication device is not a cell phone, aforementioned elements are not indispensable.

The portable communication device 10 may include a DSP (digital signal processor) 120 and/or a central control unit 100, encoder/decoder (not shown) and A/V converter 125, and the arrangement of those elements can be determined based on applications. Some of the devices mentioned above maybe integrated into one chip. The portable communication device 10 further comprises a display 160, OS (operation system) 145, and memory 155, wherein the memory 155 includes ROM, RAM, and nonvolatile FLASH memory. Aforementioned units can be coupled to the central control unit 100 respectively or the DSP 120. Aforementioned memory can be nonvolatile memory, micro-disk. The cable I/O interface 150 is coupled to the central control unit 100, and it may be USB or IEEE 1394.

The portable communication device 100 may also include a second wireless data transfer module 200B, which may comply with a communication protocol with communication distance shorter than the first wireless data transfer module 200A, such as WiFi, or light signal transmitting (communicating) device etc. In an embodiment, a wireless short range (local) internet module can be introduced, and LAN, MAN (metropolitan area network), or other network, such as Wi-Fi or 802.11x (x means a, b, g, n), are also compatible in the present invention. “Short range” represents that communication distance is shorter than the mobile communication distance. Further, users can connect internet or hot spots via WiFi or light signal transmitting device.

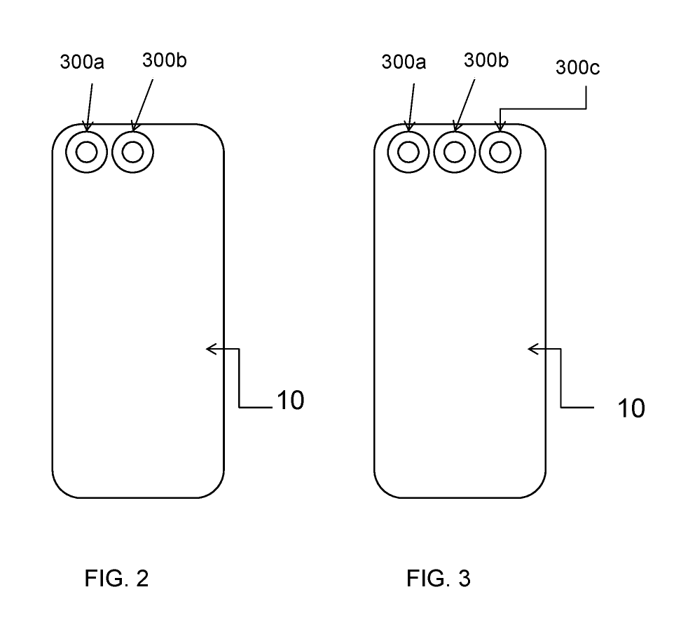

In one example, the at least dual image capture devices include stereo image capture module. The stereo image capture module and a stereo image generation module is coupled to aforementioned DSP 120 or/and the control unit 100. The stereo image capture module includes a least two image capture elements with a distance and corresponded lens (referred to FIG. 2). The image capture elements can be CMOS, or CCD with a plurality of micro-meniscus configured thereon for facilitating light concentrating and stereo imaging, and the preferable distance between them is the distance between two pupils of human if the devices are introduced to capture stereo image, if not, these arrangements are not necessary. In order to capture the stereo images, objects directly observed by human beings can be simulated by two separated image capture elements, and therefore, images with parallax can be generated due to the simultaneously captured images form different viewing angle. Those two image capture elements are preferably arranged along the major axis of the portable communication device. After two captured images are stored, the images can be processed to generate similarly or virtually stereo image, such that it can benefit producing stereo images, photos, stereo table-cloth on the screen, stereo images used for the address book, etc. The stereo images can be synthesized by a left image and a right image. The imaging process may also include zooming, rotating, translating, swapping left and right images, trimming, smoothing display by noise reduction, and so on. It's much better if the 3D display can be introduced, such as Sharp's Auto3D LCD, Horizontal Interleaved 3D Display, ex: vRex microPol 3D LCD, or Vertical Interleaved 3D LCD, ex: DTI, Pavonine. A stereo display is also disclosed in the United States patent application numbered 2009015365. JPS Builder synthesize technology, such as the synthesize technology developed by Texnai Incorporate, can be applied to rebuild stereo images, and aforementioned technology is recited herein as an example rather than limiting the present invention. The stereo images generated by the portable communication device can also be uploaded to websites, blogs, or other devices through the first wireless data transfer module 200A and the second wireless data transfer module 200B, and that is direct and convenient because the AP and the memory card are not required.

The present invention includes a front image capturing device 650, a first rear image capturing device 600 and a second rear image capturing device 660. The stereo image generation module can also configured at the remote terminal, and images captured by the first rear image capturing device 600 and the second rear image capturing device 660 can be transferred to remote terminal to be processed via connection between remote computers or servers and the first wireless data transfer module 200A or the second wireless data transfer module 200B; or after connected, the stereo image generation module can be activated by the portable communication device 10 to execute stereo images processing procedure, and the processed stereo image can be stored in remote computers, servers or the portable communication device 10.

In some embodiments, the first rear image capturing device (camera module) 600 includes a first tunable lens (lenses) with a first zoom capability, and the second rear image capturing device (camera module) 660 includes a second lens (lens set) with a fixed focal length.

In some embodiments, first rear image capturing device (camera module) 600 includes a first tunable lens (lenses) with a first zoom capability, and the second rear image capturing device (camera module) 660 includes a second tunable lens with a second zoom capability. The first zoom capability is better than the second zoom capability.

Please refer to FIG. 2, in some embodiments, first rear image capturing device 600 includes a first camera unit 300a having a first tunable lens (lenses) and a first image sensor attached a chassis of the first camera unit, and the second rear image capturing device 660 includes a second camera unit 300b having a second lens set and a second image sensor attached a chassis of the second camera unit. The first camera unit 300a has the first tunable lens with the first zoom capability, and the second camera unit 300b has the second lens set with a fixed focal length.

In some embodiments, the first rear image capturing device 600 includes a first camera unit 300a having a first tunable lens (lenses) and a first image sensor attached a chassis of the first camera unit, and the second rear image capturing device 660 includes a second camera unit 300b having a second tunable lens (lenses) and a second image sensor attached a chassis of the second camera unit. The first camera unit 300a has the first tunable lens (lenses) with the first zoom capability, and the second camera unit 300b has the second tunable lens (lenses) with the second zoom capability. The first zoom capability is better than the second zoom capability. In some embodiments, the first tunable lens (lenses) has a first zoom range and the second tunable lens (lenses) has a second zoom range, wherein the first zoom range is different from the second zoom range.

In some embodiments, the first camera unit 300a and the second camera unit 300b are a fixed-lens camera unit.

Please refer to FIG. 3, the present invention includes the first camera unit 300a having a first tunable focal length lens (lenses) and a first image sensor attached a chassis of the first camera unit, a second camera unit 300b having a second tunable focal length lens (lenses) and a second image sensor attached a chassis of the second camera unit, and a third camera unit 300c having a third tunable focal length lens (lenses) and a third image sensor attached a chassis of the second camera unit. The first camera unit 300a has the first tunable focal length lens (lenses) with the first zoom capability, the second camera unit 300b has the second tunable focal length lens (lenses) with second zoom capability, the third camera unit 300c has the third tunable focal length lens (lenses) with third zoom capability. The first zoom capability is better than the second zoom capability, and the second zoom capability is better than the third zoom capability. In one example, the focal length of the first tunable lens (lenses) and the second tunable lens (lenses) may be changed by adjusting the curvature of the first tunable lens (lenses) and the second tunable lens (lenses), respectively. The first tunable lens (lenses) and the second tunable lens (lenses) have variable curvature for auto-focusing. In one embodiment, the first tunable lens (lenses) and the second tunable lens (lenses) are an electrically tunable-focusing element, such as a liquid lens, electrically tunable-focusing liquid lens (lenses), or electrically tunable-focusing liquid crystal lens (lenses). In another example, the focal length of the first tunable focal length lens (lenses), the second tunable focal length lens (lenses), and the third tunable focal length lens (lenses) may be changed by adjusting the curvature of the first tunable focal length lens (lenses), the second tunable focal length lens (lenses) and the third tunable focal length lens (lenses), respectively. The first tunable focal length lens (lenses), the second tunable focal length lens (lenses) and the third tunable focal length lens (lenses) have variable curvature for auto-focusing. In one embodiment, the first tunable focal length lens (lenses), the second and the third tunable focal length lens (lenses) are an electrically tunable-focusing element, such as a liquid lens, electrically tunable-focusing liquid lens (lenses), or electrically tunable-focusing liquid crystal lens (lenses).

For example, the electro-optic properties of electrically tunable-focusing liquid crystal lenses includes a spatially inhomogeneous electric field which decreases gradually from the edge to the center makes the gradient-rotation distribution of liquid molecules to produce parabolic distribution of refractive indices. The principle of electrically tunable-focusing is that the curvature of the distribution of refractive indices can be changed by applied voltages.

For auto-focus liquid lens, a sealed cell contains two liquids which are immiscible, oil and water. The shape of the oil drop is changed by electrowetting. Electrowetting is the modification of the wetting properties of a surface (which is typically hydrophobic) with an applied electric field. The electrowetting effect has been defined as “the change in solid-electrolyte contact angle due to an applied potential difference between the solid and the electrolyte”. Both liquids are transparent, with different indices of refraction but exactly the same density. The cell contains only those two liquids and this density matching makes the whole lens very stable against mechanical shocks. The liquid lens external shape is fixed, there is no moving part: only the internal liquids change shape.

The first camera unit 300a and the second camera unit 300b may be configured (located) on the front of the device 10 or the rear of the device 10. Alternatively, all of the three camera units 300a, 300b and 300c may be configured (located) on the front of the device 10 or the rear of the device 10.

For example, the first camera unit 300a and the second camera unit 300b are sometimes called “optical sensors” for convenience, and may also be known as or called an optical sensor system.

The first image sensor and the second image sensor may include charge-coupled device (CCD) or complementary metal-oxide semiconductor (CMOS) phototransistors. The first image sensor and the second image sensor receive light from the environment, projected through one or more lens, and converts the light to data representing an image. In conjunction with imaging module 600, and 660 (also called a camera module) may capture still images or video. In some embodiments, the first camera unit 300a is located on the back of device 10, opposite touch screen display on the front of the device 10, so that the touch screen display may be used as a viewfinder for still and/or video image acquisition. In some embodiments, and the second camera unit 300b is located on the front of the device 10 so that the user's image may be obtained for videoconferencing while the user views the other video conference participants on the touch screen display. In some embodiments in which multiple cameras or optical sensors are supported, each of the multiple cameras or optical sensors may include its own photo sensor(s), or the multiple cameras or optical sensors may be supported by a shared photo sensor. Likewise, in some embodiments in which multiple cameras or optical sensors are supported, each of the multiple cameras or optical sensors may include its own image processing pipeline of processors and storage units, or the multiple cameras or optical sensors may be supported by an image processing pipeline of processors and storage units.

Optically the choice of liquid lens location comes from the overall system organization and function of the device 10.

Some embodiments enable this mixed image(s) or video captured by simultaneously recording using first camera unit 300a while at the same time using the second camera unit 300b. After capturing a data structure including both image(s) or video streams the awesome moment, some embodiments provide for mixed image(s) or video data structure and an interface for the image or video streams from the two separate camera units to be manually or automatically edited and combined to create a more engaging data/media which may contain normal video, high resolution video, motion video, and still images.

The user image data captured by the image capture device 600 can be transformed to digital data, and the digital data can be formed to be data stream via composed, compressed, or processed. Self-images can be generated by the self-image generation module, followed by exhibited on the display 160 immediately or timely. For example, the user can see his self-image by the mirror image or the image after adjusted, wherein the display and the lens are at the same side. By aforementioned features, aspects, teaching, optical theory, and photograph imaging theory, users are able to see the self-image when making a photo instead of just seeing the object to be taken, and meanwhile, the displayed image is mirror image. The high performance zooming lens cannot be integrated into the smart phones due to the devices required thinner thickness. Therefore, it is impossible to achieve better optical zooming capability in prior art. Thus, the present invention provides a successive extension camera lens with different zooming capabilities. The suitable zooming lens is (lenses are) employed, and these image capturing devices with selected zooming lens are activated independently or simultaneously. The user may select the better picture or video. The present invention includes a zooming mode selector 602 is coupled to the control unit, and a zooming switcher 605 is coupled to the zooming mode selector 602 to achieve the selected lens with desired mode. The first, second and the third zooming lens (lenses) may be employed, the zooming mode selector 602 and the zooming switcher 605 are performed functions automatically or manually. The first camera unit with a first zooming lens 610 captures a first image of a first visual field. The second camera unit with a second zooming lens 620 captures a second image of a second visual field. The third camera unit with a third zooming lens 630 captures a third image of a third visual field, as shown in FIG. 5. In some embodiments, the first camera unit includes a first optical package with a first focal length. In some embodiments, the second camera unit includes a second optical package with a second focal length. In some embodiments, the first focal length is different from the second focal length, and the first visual field is a subset of the second visual field. In some embodiments, the first image and the second image are preserved to a storage medium as separate data structures.

In some embodiments, the first camera unit includes a first tunable focal length lens configuration with a longer focal length than the lens of the second camera unit, and the second camera unit includes a second tunable focal length lens configuration with a longer focal length than the lens of the third camera unit. The zoom selector 600A includes the zooming mode selector 602 coupled to the processing unit configured to control that all of the first image, the second image and the third image are simultaneously captured, alternatively, any two of the first, the second and the third images are simultaneously captured. The zooming mode selector 602 may also control to select which one of the camera units is employed according to the visual field. The zooming switcher 605 is responsive and coupled with the zooming mode selector 602 to switch to the mode selected. In some embodiments, the program instructions are computer-executable to store the first image, the second image, and the third image. Thus, successive extension zooming lens of the present invention may achieve the purpose of capturing the image(s) corresponding with the short range, intermedia range and long range visual field.

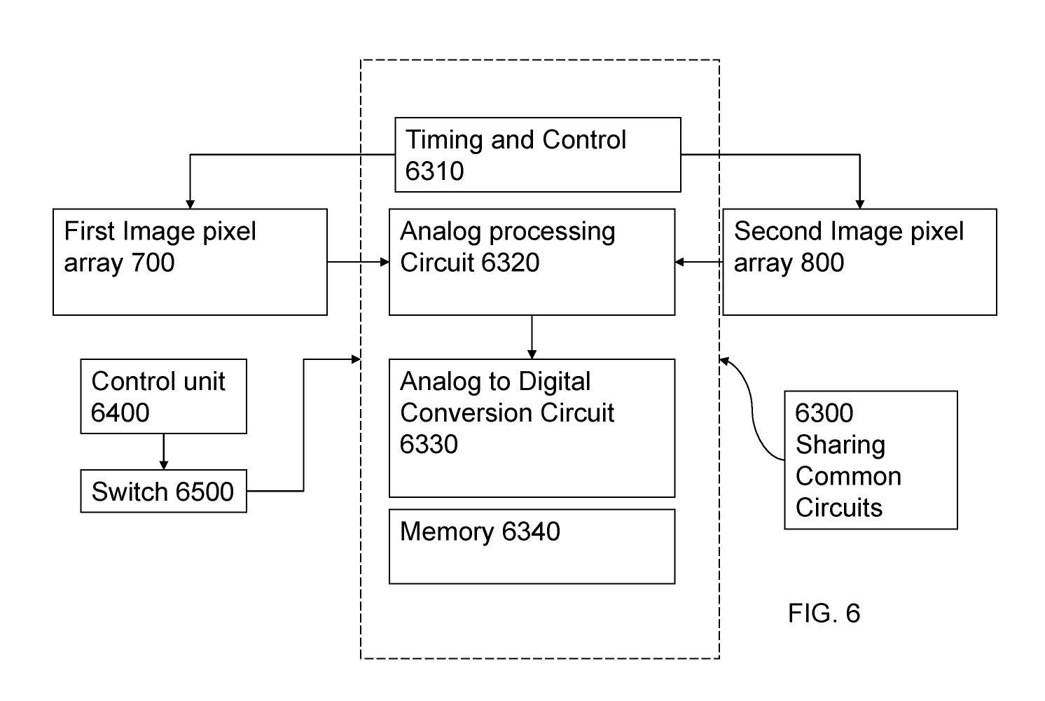

The image sensors or the image sensing module according to an embodiment of the present invention includes: a first camera unit having a first image sensing pixel array 700, and a camera unit having a second image sensing pixel array 800 as shown in FIG. 6. Each of the first and second image sensing pixel array, the image sensing chip includes a system controlling unit, a vertical scanning circuit, a pixel array, a PLL (Phase Locked Loop), a horizontal scanning circuit, and a sense amplifier. The well-known amplifying device (for example a transistor) is employed for amplifying a charge corresponding to an amount of light received by a photodetector, and outputting a pixel signal; ramp signal generator (for example a reference voltage circuit) for generating a ramp signal; and comparator for comparing the pixel signal output by the amplifying device with the ramp signal output by the ramp signal generator. Each pixel contains a photodetector and an active amplifier. The MOS is a simple switch in the pixel to read out the photodiode integrated charge. Pixels were arrayed in a two-dimensional structure, with access enable wire shared by pixels in the same row, and output wire shared by column. The vertical scanning circuit sequentially supplies a signal for controlling output of a pixel signal to pixels arranged in a vertical direction of the pixel array in predetermined timing according to control of the system controlling unit. The PLL generates a clock signal of a predetermined frequency necessary to drive each of the blocks within the CMOS sensor on the basis of an externally supplied clock signal (CK). The PLL then supplies the generated clock signal to the reference voltage circuit.

The embodiment includes a sharing common circuits 6300 for processing the first image sensing pixel array 700, and the second image sensing pixel array 800 independently or simultaneously. A switch 6500 controlled by a control unit 6400 is coupled with the sharing common circuits to switch the sharing circuits to process the signal for the first image sensing pixel array 700, and the second image sensing pixel array 800. Thus, the present invention may reduce the cost and thickness. In one example, the sharing common circuits 6300 includes timing and control 6310, analog processing circuit 6320, analog to digital conversion circuit 6330 and Memory 6340.

To benefit applications of the present invention, single or multi-illumination sources module 170 coupled to the control unit 100 is introduced for generating mirror image under dusky or dark circumstance. A choice interface is coupled to the multi-illumination sources module to facilitate to choose modes. A light sensor is coupled to the multi-illumination sources module. When the light intensity is less than a predetermined level, the control unit will activate the multi-illumination sources module based on the detected signals of the light sensor, thereby providing desired light for video communication or taking a photo. One mode of the multi-illumination sources may be night vision mode such as IR (infrared) mode, which enables the user to take photo under dark circumstance. Aforementioned illumination module comprises IR device or LED. Further, the illumination module comprises a xenon illumination device. For example, the gas is mixed, and the main component is nitrogen and a certain amount of argon, neon, xenon or krypton is introduced for providing a catalyst for nitrogen being ionized. The user can choose appropriate illumination according to different situations and different purposes, and the feature is that the present invention can be executed under dusky or dark circumstance.

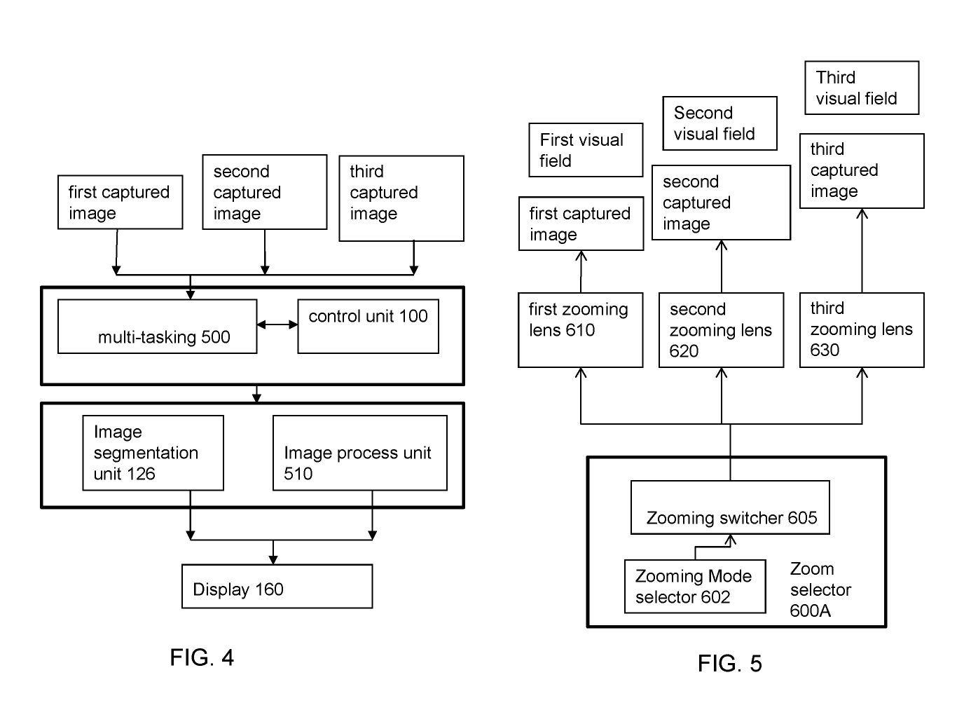

The portable communication device 10 comprises an image segmentation unit 126 coupled to the control unit 100 for simultaneously dividing the display areas on the display for displaying multiple images. Any one, both or all of the captured first, second, and third images will be assigned to the divided displaying areas which may be separated, overlapped, or partially overlapped. Referred to FIG.4, a plurality of captured images are transferred to multi-tasking module 500 for processing received images form any one, both or all of the first, second and (or) third camera units. Before the image data signals transmitted to the display 160, aforementioned images are previously processed by the image segmentation unit 126. The image process unit 510 can be introduced to adjust the processed image before displaying.

Aforementioned description is to illustrate purposes of the present invention, technical characteristics to achieve the purposes, and the advantages brought from the technical characteristics, and so on. And the present invention can be further understood by the following description of the preferred embodiment accompanying with the claim.

What is claimed is:

1. A portable communication device with zoom capability, comprising
a control unit;
a first communication module coupled to said control unit;
a display coupled to said control unit;
an image capture module having a first camera unit with a first tunable focal length lens to capture a first image of a first visual field, and a second camera unit with a second lens to capture a second image of a second visual field; and
an image segmentation module coupled to said control unit to divide display areas of said display;
wherein said first tunable focal length lens has zoom capability and said second lens has a fixed focal length.

2. The portable communication device according to claim 1, further comprising at least one image sensor for said first camera unit and said second camera unit, wherein said at least one image sensor comprises CMOS or CCD.

3. The portable communication device according to claim 1, further comprising a third camera unit with a second tunable focal length lens to capture a third image of a third visual field.

4. The portable communication device according to claim 1, further comprising a zoom selector coupled to said control unit.

5. The portable communication device according to claim 1, further comprising a second communication module coupled to said control unit.

6. The portable communication device according to claim 5, wherein said second communication module includes Wi-Fi module.

7. The portable communication device according to claim 5, wherein said second communication module includes light signal communicating module.

8. The portable communication device according to claim 1, wherein said first camera unit and said second camera unit are formed rear or front side of said portable communication device.

9. The portable communication device according to claim 1, wherein said first tunable focal length lens is an electrically tunable-focusing element.

10. The portable communication device according to claim 1, wherein said first tunable focal length lens is an electrically tunable-focusing liquid lens or an electrically tunable-focusing liquid crystal lens.

11. A portable communication device with zoom capability, comprising
a control unit;
a first communication module coupled to said control unit;
a display coupled to said control unit;
an image capture module having a first camera unit with a first tunable focal length lens, and a second camera unit with a second tunable focal length lens;
wherein said first tunable focal length lens has a first zoom capability and said second camera unit has a second zoom capability, and wherein said first tunable focal length lens has a first zoom range and said second tunable focal length lens has a second zoom range different from said first zoom range.

12. The portable communication device according to claim 11, further comprising at least one image sensor for said first camera unit and said second camera unit, wherein said at least one image sensor comprises CMOS or CCD.

13. The portable communication device according to claim 11, further comprising a third camera unit with a third tunable focal length lens having a third zoom range different from said first or second zoom range.

14. The portable communication device according to claim 11, further comprising a zoom selector coupled to said control unit.

15. The portable communication device according to claim 11, further comprising a second communication module.

16. The portable communication device according to claim 15, wherein said second communication module includes Wi-Fi module.

17. The portable communication device according to claim 15, wherein said second communication module includes light signal communicating module.

18. The portable communication device according to claim 11, further comprising an image segmentation module coupled to said control unit to divide display areas of said display.

19. The portable communication device according to claim 11, wherein said first tunable lens and said second tunable lens are an electrically tunable-focusing element.

20. The portable communication device according to claim 11, wherein said first tunable lens and said second tunable lens are an electrically tunable-focusing liquid lens or an electrically tunable-focusing liquid crystal lens.
